(19) United States
(12) Patent Application Publication
(10) Pub. No.: US 2011/0170998 A1
(43) Pub. Date: Jul. 14, 2011

(54) Method and Apparatus for picking articles into order load supports in a completely automated and manless manner

(76) Inventor: Max Winkler, (US)

(21) Appl. No.: 12/978,040

(22) Filed: Dec. 23, 2010

Related U.S. Application Data
(63) Continuation of application No. PCT/EP2009/005400, filed on Jul. 25, 2009.

(30) Foreign Application Priority Data
Aug. 29, 2008 (DE) 10 2008 046 325.6

(51) Int. Cl. B65G 47/90

(52) U.S. Cl. 414/564; 414/814

(57) ABSTRACT

The present invention relates to a system for picking a plurality of different articles in a fully automated manner, which are preferably stored in storage load supports (70, 72), into order load supports (34) in accordance with a picking order, comprising: a first conveyor (18) conveying the plurality of different articles (52), which are to be picked, from an article warehouse (16) as an article stream downstream relative to a manlessly operated order-picking station (37) including a fully automated gripping unit (30); at least one gripping unit (30), which can be lifted and lowered and which is particularly mounted on a ceiling, for gripping one, in particular one single, arbitrary article (52) from the stream at a receiving point (62) within a gripping area (56) on the first conveyor (18) and for transferring the gripped article (52) to a delivery point (60) outside the gripping area (56), wherein the receiving point (62) and the delivery point (60) are located within a working area (54) of the gripping unit, which preferably is almost circular, and wherein the arbitrary article (52) is vertically lifted from the stream, substantially displaced in a horizontal direction and subsequently moved vertically downwards when being transferred, wherein the gripping unit (30) can grip and transfer up to 1,500 articles each hour; a control unit (31; 69) coordinating the gripping and transferring movements of the gripping unit (30) such that predetermined articles (52) of the stream can be gripped and transferred individually; and an order load support buffer (35; 35′) for buffering one or more order load supports (34) at a corresponding number of destinations, wherein the buffer (35) is coupled to the gripping unit (30).

### RELATED APPLICATIONS

This is a continuation application of the co-pending international application PCT/EP2009/005400 (WO 2010/022832) filed on 25 Jul. 2009 which claims priority of the German patent application DE 10 2008 046 325 filed on 29 Aug. 2008 which is fully incorporated by reference.

### BACKGROUND OF THE INVENTION

The present invention relates to a system for fully automated manless picking of articles, which are preferably stored in storage load supports, into order load supports, namely in accordance with a picking order. The present invention further relates to a method for picking in a fully automated and manless manner.

### RELATED PRIOR ART

Nowadays, substantially two order-picking strategies exist which are caused by a technical organizational equipment. The first strategy operates in accordance with the “man-to-goods” principle. The second strategy operates in accordance with the “goods-to-man” principle. A temporal-spatial processing of picking orders is determined dependent on the strategy. One picking order includes a number of positions (lines) representing different articles in different numbers.

Typically, one works according to the “goods-to-man” principle with a huge article assortment comprising a plurality of different article types. For example, storage containers are then conveyed from a container warehouse to a picking station where a picking person manually takes the articles from the storage containers and puts the same into order containers which are arranged in the region of the picking station. A material flow computer or warehouse management computer respectively assigns one picking order to each of the order containers and takes care that the right storage container, holding the articles required for the respective picking order, is conveyed to the picking station where the associated order container is processed.

If the article assortment is not too large, and if the to-be-picked articles can be stored well and recalled in great numbers, typically so-called A-frames or order-picking automatons are employed. The document U.S. Pat. No. 5,755,552 discloses an exemplary A-frame. An A-frame is an order-picking automaton dispensing articles via shafts, in which the articles are stacked on top of each other, on a central conveyor belt, which is centrally arranged between the A-shaped legs of the automaton frame. In this context, one also speaks of shaft order-picking devices. A shaft order-picking device is used, in particular, for smaller units which are stably packed, e.g. in the field of pharmaceuticals. Several shaft order-picking devices can achieve, together with a common conveying belt, very high performances (up to several 10,000 pieces each hour) in the typically parallel operation. For this purpose, the shafts are arranged one behind the other in the longitudinal direction of the belt, and are adapted for receiving different article types. A so-called dispenser is provided at the lower end of each shaft, the dispenser supporting the discharge of articles, which are stored in the shaft, on the belt. The shafts are typically filled in a manual manner, which can represent a drawback in case of very high order-picking performances (e.g. 100 articles/minute), because the shafts are not filled sufficiently fast.

With the above-mentioned conventional picking stations, picking performances in the magnitude of up to 1,000 articles each hour can be realized. In this context, the picking person represents a bottle neck since he/she works manually, and the maximum number of picks is thus limited to about 1,000 each hour.

In spite of relative low picking performances—in comparison to an order-picking automaton—conventional picking stations must be employed, since not each article can be stored within an automaton shaft. In particular, round articles such as bottles or the like are difficult to handle with order-picking automatons. The same applies for articles having greater dimensions, wherein only a small number thereof can be stored in each order-picking shaft of an order-picking automaton.

Although the order-picking automaton represents a fully automated and manlessly functioning system, there is a need for an additional automation, in particular in the field of articles which cannot be handled with order-picking automatons.

Even further, unloading robots and loading robots are known, particularly in order to load articles onto pallets or take articles from the pallets. In the document DE 10 2006 024 900 A1 a device for handling pallets inside and outside of a so-called palletizing cell is described. Empty pallets are positioned at a loading station for being loaded. Then, articles such as boxes are conveyed to the palletizing robot via a roller conveyor for stacking the articles on the pallet. A suction lifting device of the palletizing robot is used for transferring the articles from the roller conveyor onto the pallet, the suction lifting device being mounted above the roller conveyor in a horizontally and vertically movable manner on a frame-like rack. Up to several 100 articles each hour can be transferred with such an overall device. Similar is true for depalletizing robots working inversely, i.e. pallets loaded holding an article stack are depalletized layer-by-layer or individually.

Apart from the relatively high room and space requirements of such robots, they are just not suitable for being used in order-picking systems due to their low performance (gripping and transferring operations/hour), particularly not for the process of transferring articles from storage load supports into order load supports. Such robots are not adapted to the gripping of smaller article units such as boxes. Previous conventional robotic solutions are substantially limited to the handling of so-called bulk ware or articles in cardboard boxes, or to repackaging (typically four or more articles per unit).

Packing robots or palletizing robots, as mentioned above, are disclosed in the documents DE 40 27 497 A1 and U.S. Pat. No. 5,175,692 B.

The document DE 198 20 537 A1 discloses a robot for sorting and packing sausages in order to collect the sausages for the sake of forming a next bigger unit, again as already mentioned above. A sorting robot is generally disclosed in the document WO 03/091107 A1.

### SUMMARY OF THE INVENTION

Therefore, it is an object of the present invention to provide an apparatus and a method for picking articles in accordance with picking orders in a manless and fully automated manner, wherein picking performances shall be possible which are significantly above the mark of 1,000 picks each hour. The articles, which are to be picked, are also supposed to contain articles which can be handled by an order-picking automaton not at all or only poorly. In this context, the principle “goods-to-man” is to be obeyed in particular, in order to transfer articles, stored in storage load supports, into order load supports.

This object is solved by a storage and picking system for picking a plurality of different articles in a fully automated manner, which are preferably stored in storage load supports, into order load supports, wherein the system comprises: a first conveyor conveying a plurality of the different to-be-picked articles from an article warehouse by means of an article stream oriented downstream towards a picking station, which is operated in a manless manner, having a fully automated gripping apparatus; at least one gripping unit, which can be lifted and lowered and particularly is supported on a ceiling, for gripping one, in particular one single, article being arbitrarily predetermined from a stream at a receiving point within a gripping area on the first conveyor, and for transferring the gripped article to a delivery point outside of the gripping area, wherein the receiving point and the delivery point are located within a working area of the gripping unit, which is preferably almost circular, and wherein the arbitrary article is vertically lifted from the stream during the transfer, substantially shifted in a horizontal manner and subsequently moved downwards in a vertical direction, wherein the gripping unit can grip and transfer up to 1,500 articles, preferably 4,000 articles, each hour; a control unit which coordinates gripping and transferring movements of the gripping unit so that articles of the stream, which are predetermined by the picking order, are individually gripped and transferred; and an order load support buffer for buffering one or more order load supports at a corresponding number of destinations wherein the buffer is coupled to the gripping unit.

The picking process now happens fully automated by means of a robotic gripping unit instead of a manually picking. The robot fully takes over the picker's tasks. The robot grips the article, which was initially one of the main reasons for utilizing human beings for the purpose of order picking, and transfers gripped articles at a substantially higher velocity and precision. Humans are no longer needed in a system according to the invention, at least not for the purpose of picking. The robot can grip 1,500 articles each hour from the conveyor belt without any problem, and put them, e.g., on a second conveyor belt which feeds order containers being arranged laterally relative to the second conveyor belt with the ordered articles in accordance with the picking orders, and thus serves as a sorting device. The picking performance of even up to 4,000 pieces each hour thus is exactly in the range between the conventional manual order picking (1,000 pieces each hour) and classical automaton picking (10,000 pieces each hour and more). Also, the robot does not make any faults during the gripping process. The articles are transferred, preferably in an individual manner, which is possible without any problems due to the high velocity so that always the right number of articles of one type is transferred, which is not always the case with the manual picking.

The purchase costs for such a gripping and transferring robot typically amortized within twelve to eighteen months although the purchase costs are relative high. In this context, one should consider that no personnel is needed with the system of the present invention so that personnel costs can be completely saved in long-time terms.

Further, the fault rate is substantially lower because a robot never gets tired so that decrease of concentration presently is not possible compared to humans where this becomes negative with increasing work time. The system of the present invention can work, respectively, twenty four hours on seven days.

In accordance with the preferred embodiment, the system further comprises an image recognition unit for detecting and evaluating a position or location as well an orientation of each article of the stream on the first conveyor, wherein the image recognition unit is arranged downstream relative to the gripping unit and can resolve, and particularly identify, even articles which are orientated chaotically within the stream.

The image recognition unit can be a camera system by which images of the distribution of the articles on the first conveyor are recorded. In this context, it is not relevant whether the articles are conveyed directly on the conveyor or within load supports. The image processing software, which is used in accordance with the present invention, is capable of resolving even articles in an upper layer of a stack of articles such that a respective location (position) and a respective orientation are known, in order to allow transmittal of corresponding position data (relative to the conveyor) to the gripping unit for gripping the articles. The image processing is correspondingly easier if the articles are presented in a somehow organized manner, for example, in a container or on a tray divided into compartments. Then, the image recognition unit only needs to determine the location of such articles which are actually present.

Even further, it is preferred if each article is conveyed to the gripping area on a respective article load support at a position, which is respectively defined fixedly on the first conveyor, and is gripped and transferred from there together with the article load support.

If each article is provided on a separate article load support, such as a tray, the gripping device can be operated without image recognition. For this purpose it is required that these trays are oriented at predetermined (raster) points relative to the first conveyor such as a conveyor belt before they enter the working and gripping area of the gripping unit. Then, a superordinated control device such as a material flow computer or a warehouse management computer is aware of the fact which article is arranged at which position of the conveyor belt. Thus, due to the knowledge of the conveyor velocity, the position and orientation of a to-be-picked article can be predicted and be transmitted in advance in terms of position control data to the gripping unit. Further, the geometrical dimensions of the articles can be stored in the system, in order to transmit in advance the right start positions (from above, from the left, from the right, etc.) to the gripping unit for initiating a gripping process.

Despite of the outstanding reliability of nowadays image processing programs, this solution represents a possible way if an image recognition unit is not desired. This aspect plays a particular role when retrofitting or re-equipping order-picking systems which already exist. The transmittal of control data for a robot is possible without problems by means of conventional systems. However, evaluation of start positions, particularly for elder systems, represents a bigger computational challenge, so that some operators of order-picking systems might want to do without an image processing. This is possible in the above-described manner.

In accordance with another preferred embodiment, the gripping unit can transfer articles of a respective total weight from up to 2 kg at accelerations of up to 150 m/s². The working area preferably has a diameter of 1,500 mm, particularly if the lift preferably is 60 mm.

The gripping robot, as used with the present invention, can effect accelerations of up to 10 g without a load. This characteristic allows the enormous velocity during the transfer, and thus the increase of the picking performance to a magnitude of even up to 4,000 articles each hour.

Another advantageous embodiment is possible if at least a second conveyor is provided, which couples in the working area of the gripping unit to the first conveyor in an oblique manner, particularly perpendicular, and which is connected to the order load support buffer, in particular to the destinations.

In this case, the second conveyor serves as a sorter and supplies a plurality of destinations, or order load supports such as order containers, with the to-be-picked articles. This is particularly advantageous if a number of gripping robots are arranged sequentially one after the other relative to the first conveyor line. Then the first gripping robot can grip such articles from the article stream which might be arranged chaotically in the article stream without removing all the other articles of the stream from the first conveyor line which are not assigned to destinations of the second conveyor associated with this gripping unit, like it happened, for example, with conventionally used linear pushers, rotating pushers, stoppers, etc. An aimed access to articles, which can be selected arbitrarily, of the article stream on the first conveyor is possible at outstanding velocities.

In accordance with another preferred embodiment, the second conveyor comprises a number of driven accumulation conveyors and/or gravity tracks, each of which can end in one of the destinations. The usage of accumulation conveyors or tracks has been found particularly advantageous since, in this case, the traffic of the order load supports flows better, particularly if the order load supports rest on an order load support conveyor line during their filling, i.e. are not discharged to a buffer. By means of the accumulation conveyors, all the articles of an order can be collected before they are delivered to the order load support. While the articles are collected, the order load supports can be transported on the order load support conveyor, thereby passing freely the accumulation conveyors. Only in the case of a transfer of a collected, and thus completed, order, the load support stream on the order load support conveyor is stopped. This increases the throughput of order load supports in the entire system.

With a particular embodiment of the invention the second conveyor is arranged at one height with the first conveyor and/or below the same.

Since the gripping unit preferably has only one lift, it is advantageous if the second conveyor is arranged almost at the same level like the first conveyor. Articles, which have been gripped by the gripping unit, can be discharged from above the second conveyor in an arrangement where the second conveyor is arranged beneath the first conveyor. In this manner it is possible that a number of second conveyor lines can be arranged on top of each other, namely at a respective slightly horizontal displacement so that each second conveyor line comprises an associated discharge window allowing to discharge articles thereon. Of course, this only applies under the assumption that the articles do not break when being discharged.

Gravity tracks are advantageous in that a movement of the articles being located on the gravity tracks do not require a drive. For example, the gravity tracks can be implemented in terms of relatively smooth sheet metals (chutes), idle roller tracks, etc., which are inclined downwards from the first conveyor towards the order load supports.

Additionally, it is advantageous if the control unit regulates a conveyor velocity of the first conveyor in dependence on the article density on the first conveyor.

If the article density is very high, it can be advantageous for several reasons if the conveyor velocity is decreased. On the one hand, this facilitates, in case of computer-aided image recognition (article identification including position and orientation determination), the resolution of individual articles on the first conveyor. If many articles are located on the first conveyor, the decrease can even be required necessarily for providing enough time to the image recognition unit, thereby providing sufficient calculation time for an identification. However, if only a few articles are present on the first conveyor, i.e. if the article density is low, the first conveyor can be operated at a higher conveyor velocity, if necessary. The gripping unit is typically capable of following an article, even at a high velocity, on the first conveyor during a gripping process.

In accordance with another preferred embodiment, there is provided additionally an order load support conveyor which runs beneath the first conveyor in the working area of the gripping unit and/or connects the destinations to a shipping area.

If an order load support conveyor, such as an order container conveyor, runs directly beneath the first conveyor, namely within the area of the gripping unit, the gripping unit can discharge gripped articles directly into an order container. If the order container stream and the article stream are matched to each other correspondingly, the order container can be loaded with a to-be-picked article during its travel below the gripping unit.

If a number of gripping units are arranged one after the other, and if the order container conveyor is guided in an S-shaped manner beneath this plurality of gripping units, the order containers can be filled during a continuous travel thereof. In this case, the S-shaped order container conveyor section is to be regarded as an order load support buffer.

A direct connection of the order load support conveyor to the shipping area allows direct transport of a completely picked order container out of the system of the invention. The containers do not need to be buffered but can be loaded directly to transport vehicles, which are preferably waiting. This in turn increases the throughput because the resting period of an order load support inside the system of the invention is shortened.

With another particular embodiment, the first conveyor can guide up to 1,800 storage load supports each hour through the gripping area, wherein the storage load supports are loaded with articles of one sort only, and/or are divided into compartments.

For example, storage containers, trays or the like can be used as storage load supports. If the container or the tray is loaded with articles of one single sort only, this is called a “varietally pure” loading. However, both containers and trays can also be divided for storing goods of different types in one and the same load support by respectively one sort only. If each container or tray is divided into four regions, then up to 7,200 different article types can be led passed one gripping unit each hour with a throughput of 1,800 containers, or trays, each hour. Typically, article assortments which are handled by the present invention include between 5,000 and 7,000 different article types. In this sense, the entire warehouse (article assortment) can be led passed the gripping unit at least once an hour. Article types being recalled particular frequently can be stored multiple times in even different storage load supports so that these article types are led passed the gripping unit repeatedly. Article types which in turn are recalled less frequently, i.e. are less frequently present in orders, can be stored in the entire article assortment in correspondingly reduced numbers. The classical ABC distribution can be taken into account. It is clear that the just mentioned numbers are of exemplary nature and were only provided for the purpose of illustration by means of an example out of the practice.

With a particular embodiment the control unit is adapted to track receiving points during a continuous conveying operation of the first conveyor such that the gripping unit can grip articles from the first conveyor without the first conveyor being stopped.

This measure in turn increases the throughput of the articles. The gripping unit is adapted to grip the article from the first conveyor while the first conveyor moves. It is necessary that the gripping unit is provided with position information of the to-be-gripped article for allowing such movements to be performed. If the conveyor velocity of the first conveyor is known, the control unit can pre-calculate a receiving point, where the gripping unit grips the to-be-gripped article, such that a gripper of the gripping unit is moved to this pre-calculated receiving point just in the right time.

The above-mentioned object is further solved by a method for picking articles in a manless and fully automated manner, preferably from storage load supports, into order load supports in accordance with a picking order, wherein the method comprises the following steps: providing a gripping unit; conveying a stream of different articles, which are to be picked and can be orientated chaotically, to the gripping unit; gripping individual, arbitrarily selectable, articles from the first conveyor and transferring the gripped articles to a delivery area being coupled to order load supports which are buffered in an order load support buffer, which can receive one or more order load supports; wherein the gripping unit grips and transfers up to 1,500 articles each hour.

In particular, the articles are detected by means of an image recognition unit before they are gripped and transferred, in order to determine their respective location (position on the first conveyor) and orientation, or they are orientated at predetermined raster points, wherein the articles are preferably located on article load supports.

The advantages associated with the method of the invention have already been described in connection with the apparatus and will be understood even better from the following detailed description.

### BRIEF DESCRIPTION OF THE DRAWINGS

It is clear that the above-mentioned and hereinafter still to be explained features cannot only be used in the respectively given combination but also in other combinations or alone without departing from the scope of the present invention.

Embodiments of the invention are illustrated in the drawings and will be explained in more detail in the following description, wherein:

FIG. 1 shows a top view of a system of the invention;

FIG. 2 shows a perspective side view of a gripping unit;

FIG. 3 shows a schematic top view of a manless fully automated order-picking station in accordance with the present invention;

FIG. 4 shows a top view of a first modification of the system of the invention;

FIG. 5 shows an isolated top view of a modified order-picking station in accordance with the present invention;

FIG. 6 shows another top view of a still other order-picking station in accordance with the present invention;

FIG. 7 shows a side view of a further embodiment of an order-picking station in accordance with the present invention;

FIG. 8 shows a top view of a partially loaded tray which is divided into compartments;

FIG. 9 shows an isolated top view of the first conveyor having raster points, standing thereon for determining an internal reference system; and

FIG. 10 shows a flow chart of a method of the invention.

### PREFERRED EMBODIMENTS OF THE INVENTION

In the following description of the drawings similar features will be designated by identical reference numerals. Modifications will be explained explicitly.

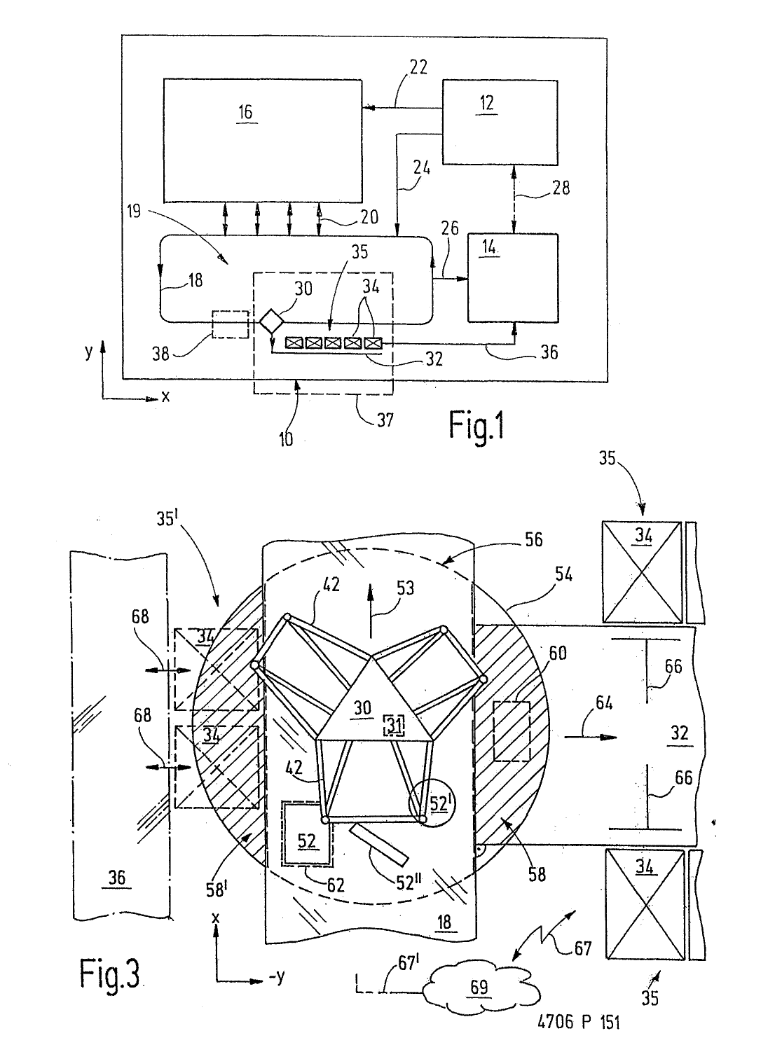

FIG. 1 shows a top view of a drastically schematized system 10 for picking in a manless and fully automated manner in accordance with the present invention. The system 10 can be installed, for example, in a facility (such as a warehouse). The system 10 can be used as storage and/or picking system.

Here, the system 10 comprises a goods receipt area 12, a goods issue area or shipping area 14, a warehouse area 16 as well as a first conveyor 18 in terms of a circular conveyor system 19. The first conveyor 18 can be implemented in terms of, for example, roller tracks, belt conveyors, chain conveyors, etc. The first conveyor 18 is connected directly to the warehouse area 16 via branch lines 20, which are indicated in FIG. 1 in the shape of double arrows. It is clear that the conveyor sections 20, which are used as storage and retrieval branches here, can be of the same conveyor type as the first conveyor 18. The circular system 19, however, can also be resolved and replaced by individual conveyor connections between the individual system components. The conveyor 18 could start, for example, in the goods receipt 12 and end in the goods issue 14, without the goods receipt 12 and goods issue 14 being connected to each other via a conveyor.

However, the warehouse area 16 can also be connected directly to the goods receipt 12 via another conveyor 22 so that to-be-stored load supports such as trays, containers, etc. do not need to be led via the circular system 19 in a complicated and long term manner, wherein the circular system 19 as such can be directly connected to the goods receipt 12 via another conveyor section 24. The circular system 19 can also be connected directly to the goods issue 14 so that, for example, storage containers can be sent from the warehouse area 16 directly to the shipping 14 without requiring a picking process (transfer of articles). This can particularly apply in case of large-scale orders including high numbers of the same article type, for example, if entire pallets, containers or trays holding articles of the same type are ordered.

Optionally, the goods receipt 12 and the goods issue can also be connected to each other directly, as indicated by a dashed line arrow 28.

A gripping unit 30 is coupled to the first conveyor 18. The gripping unit 30 grips articles which are either located directly on the conveyor 18 or on load supports, wherein the load supports as such in turn stand on the first conveyor. The gripping unit 30 is mounted preferably in a stationary manner on a facility ceiling. Optionally, it is mounted to a frame rack (which is not depicted) above the first conveyor 18. The gripping unit 30 grips articles and transfers same. In the example of FIG. 1, the articles are transferred to a second conveyor 32, such as another conveyor belt, or discharged thereon. The second conveyor 32 couples to a plurality of order load supports such as order containers 34, which can be buffered in an order load support buffer 35. In FIG. 1 the buffer 35 is directly adjacent to the second conveyor 32. By means of an order load support conveyor 36, the order load supports 34 in turn can be transported to the shipping area 14.

Processed storage load supports are transported back to the warehouse area 16 after having passed the gripping unit 30, or are transported back to the goods receipt 12, if they are empty.

A manless fully automated order-picking station is surrounded by a rectangular window being designated by the reference numeral 37, which is illustrated with a dashed line in FIG. 1. The order-picking station 37 comprises at least the gripping unit 30. The order-picking station 37 can further comprise the first conveyor 18, the second conveyor 32, as well as the order load support buffer 35.

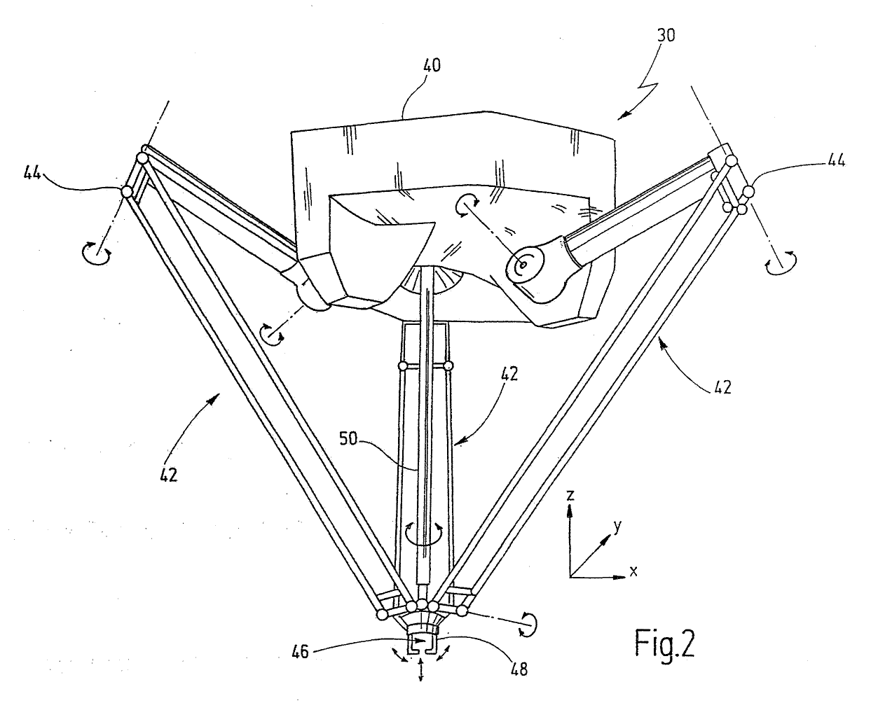

The heart of the present invention is illustrated in terms of the gripping unit 30, which is schematized in a perspective side view in FIG. 2.

The gripping unit 30 comprises a housing 40 in which a number of arms 42 is supported. In FIG. 2 exemplarily three arms 42 are shown. Here, the arms 42 exemplarily have two members, wherein the members are rotatably connected to each other by means of joints 44. The arms 42 are rotatably supported in the housing 40. Opposing ends of the arms 42 are pivotally connected to a gripper 46, which in turn exemplarily comprises two mechanical gripping pincers 48. Other gripper types such as pneumatic suction devices can also be used.

Besides the three arms 42, which allow a translatory movement in all three space directions (X, Y and Z direction), a fourth arm 50 in terms of a rotating bar 50 is connected to the gripper 46. The rotating bar 50 can rotate around its longitudinal axis, as indicated by means of a round double arrow. By means of the rotating bar 50, a fourth degree of freedom (rotation around a Z axis) is defined so that gripped articles can be rotated around the Z axis. Of course, the number of motion degrees can be increased by corresponding precautions. For this purpose, however, additional mechanical elements would be required, which would limit the weight, and thus the velocity at which the gripper 46 can be moved.

The gripping unit 30 is capable of moving individual objects or articles, which can be selected arbitrarily from a stream of articles (load supports, or article stacks and groups), particularly fast and precise from one location to another location. In this context, the velocity of the gripping unit 30 is an outstanding feature which is responsible for allowing the gripping unit 30 to conduct up to 150 gripping and transferring cycles each minute. High track velocities and outstanding position accuracy are ensured. Suitable control software allows the gripping unit 30 to follow a fast-running conveyor 19 at high accuracy.

As mentioned above, the housing 40 can either be mounted directly to the facility ceiling or to a rack, so that the first conveyor 18 (cf. FIG. 1) can pass below the gripping unit 30 without any problem. In this case, there are problems with regard to the spatial arrangement of the components. The space typically required by the picking personnel is dropped completely.

An effective area of the gripping unit 30 will be explained subsequently in more detail in the context of FIG. 3.

The gripping unit 30 has a movement radius of preferably up to 1,500 mm, wherein maximum accelerations of up to 10 g are possible. The gripping unit 30 can lift articles of up to 2 kg.

The gripping unit 30 and the housing 40 thereof are depicted in the shape of a triangle in the top view of FIG. 3. A control unit 31 can be integrated into the housing, the control unit being indicated in FIG. 3 by means of a rectangular dashed-line box.

The gripping unit 30 is arranged preferably in a central relation to the longitudinal axis of the first conveyor 18 so that a maximum area is accessible on the first conveyor 18. The gripping unit 30 comprises a working area 54 which is almost circular. The working area 54 represents such positions in space, which can be reached by the gripper 46 (cf. FIG. 2) at a maximum extracted position of the arms 42. A region of the working area 54 overlapping with the first conveyor 18 represents a gripping area 56 which is also surrounded by a dashed line in FIG. 3. The gripping area 56 is similar to a circle having two cut-off lateral circular segments.

In the right circular segment of FIG. 3 there is provided an area of the working area 54 overlapping with the second conveyor 32, which serves for transporting away articles 52, 52′, 52″ which have been transferred. This area is illustrated in a hatched manner in FIG. 3 and will be designated by the reference numeral 58. It represents a delivery area 58. Within the delivery area 58, a delivery point 60 is shown by means of a dashed line, the area of the receiving point subsequently matches the area of an article 52 which is still located on the first conveyor 18 at a receiving point 62 which is also indicated by a dashed line. If delivery or receiving points are mentioned in the following, this can also mean an area or surface. The article 52 can also be, for example, a drug packaging. Additional other article types (or shapes) are indicated on the first conveyor 18 in the shape of circles 52′ or cylinders 52″. The articles 52, 52′ and 52″ are conveyed upwards on the conveyor 18 in FIG. 3, as indicated by an arrow 53 (conveying direction).

The gripping unit 30 grips the square-shaped article 52 at the receiving point 52, while the first conveyor 18 advances continuously. As soon as the article 52 is gripped, the gripping unit 30 moves the article 52 from the gripping area 56 to the delivery area 58 and places the article 52 on the delivery point 60 on the second conveyor 32, which in this case is orientated perpendicular relative to the first conveyor 18. A plurality of order containers 34 is laterally arranged both to the left and to the right of the second conveyor 32, the order containers 34 being buffered in buffers 35.

In this case, the second conveyor 32 is realized in terms of another belt conveyor which is moved in a discrete or continuous manner along a direction of an arrow 64. In the following, it is assumed that the belt conveyor 32 is also continuously moved, in order to keep the throughput as high as possible.

After the gripping unit 30 has put down the article 52 at the delivery point 60, the article 52 is conveyed towards the buffer 35. A discharge device 66 is associated with each of the order containers 34, the discharge device being depicted exemplarily in terms of a T-shaped pusher. A superordinated material flow computer or warehouse management computer 69 coordinates the discharging of the article 52 being located on the second conveyor 32 to one of the order containers 34 by actuating one of the assigned pushers 66. The assignment of the article 52 to one of the order containers 34 has already happened earlier and is stored in the computer 69. A conveyor for transporting away the order containers 34 being depicted in the right part of FIG. 3 is not shown for the purpose of clarity.

A conveyor 36 for transporting the order containers 34 is, however, indicated in the left part of FIG. 3 by means of a dashed line. The order containers 34 can be transported to an order container buffer 35′ by means of this conveyor 36, the order container buffer optionally being adjacent directly to the first conveyor 18 and, in this case, being located in the working area 54 of the gripping unit 30. These order containers 34 are transferred between the buffer 35′ and the conveyor 36 by means of feeding/discharging devices 68 (for example, belt dischargers or belt feeders, pushers, etc.). Two order containers 34 of the buffer 35 are exemplarily arranged within another delivery area 58′ in FIG. 3, also being emphasized in a hatched manner. It is clear that also more than two order containers 34 can be supplied simultaneously with articles 52, 52′, 52″ by the gripping unit 30 if the position and arrangement of the order containers 34 of the buffer 35′ is chosen skillfully.

The left part of FIG. 3 represents a modification in comparison to the right part of FIG. 3. The order containers 34 are placed directly inside the working area 54 of the gripping unit 30. In this sense, one sequencing stage (second conveyor 32) is omitted. Consequently, the time needed for bringing one article to its assigned order container is shortened.

The conveyor 36 can also be directly adjacent to, oriented parallel, or inclined relative to the first conveyor 18. In case of a parallel arrangement, the feeding and discharging devices 68 can be saved, which are illustrated by means of double arrows in FIG. 3. The order containers 34 and the conveyor 36 do not need to be stopped while the working area 54 or the delivery area 58′ of one gripping unit is passed, if the movement processes are suitably coordinated. The gripping unit 30 can delivery the articles directly into the order containers 34 wherein, of course, it is assumed that the articles are “droppable”. Fragile articles are not supposed to be picked in this manner. As far as the arrangement of the individual components (conveyors 18, 32) in the vertical direction is concerned, this will be dealt with hereinafter in more detail.

In FIG. 3, the second conveyor 32 shall be arranged almost on the same level like the first conveyor 58. The order load support conveyor 36 is arranged on such a level relative to the first conveyor 18 that an upper edge of an order container 34 in the buffer 35′ is on the same level as the first conveyor 18, or lies beneath same. Such a vertical arrangement is recommended, since the gripping unit 30 only has a relatively low lift in its typical embodiment, but achieves very high velocities in a horizontal movement direction. The gripping unit 30, or the gripper 46 (cf. FIG. 2), can be accelerated by up to 10 g, the gripper 46 can also be formed by means of a pneumatic suction device.

With a modified shape of the gripping unit 36 an additional vertical lift unit is mounted in the area of the gripper 46 to a lower end of the arms 42, in order to allow generation of an additional lift. Then, with this embodiment the gripper 46 is preferably formed by means of a pneumatic suction device.

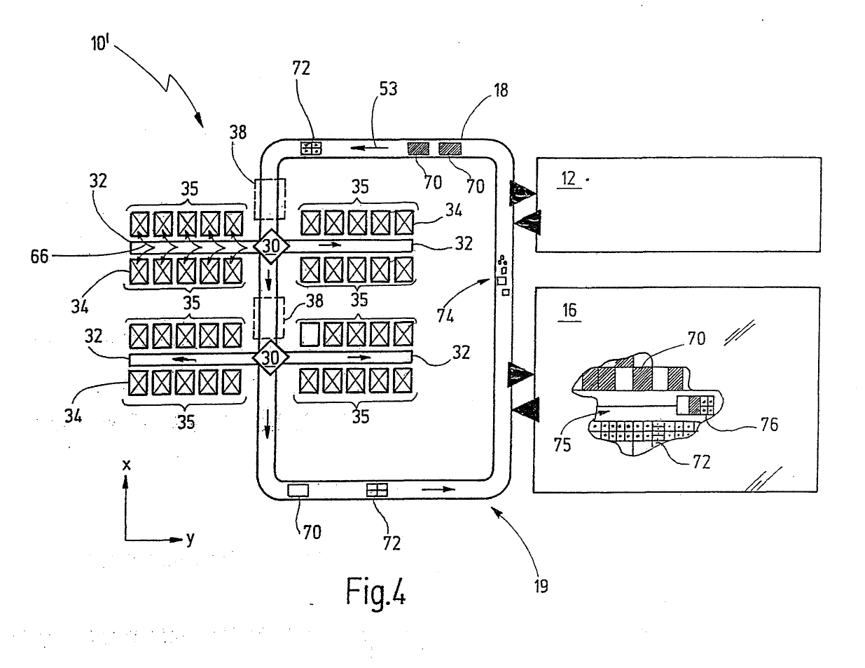

In FIG. 4 a top view of another embodiment of an order-picking system 10′ in accordance with the present invention is shown.

The system 10′ of FIG. 4 comprises, similar to the system 10 of FIG. 1, a goods receipt 12 and a warehouse 16 which are connected to a circular system 19 of the first conveyor 18 by means of conveyor elements, which are not designated in more detail here and depicted by dark triangles.

In the system 10′ two gripping units 30 are arranged serially one behind the other for unloading load supports 70, 72, or gripping articles, like they are depicted at 74, being directly located on the first conveyor 58, and transferring same to second conveyors 32. The storage load supports 70, 72, or a collection 74 of articles, are transported on the first conveyor 18 in a counter-clockwise manner from the goods receipt 12, or the warehouse 16, to the gripping units 30, as shown by an arrow 53.

Preferably, respectively one image recognition unit 38 is arranged for each of the gripping units being located upstream. The image recognition unit 38 can be formed by means of a camera system which is arranged above the first conveyor 18 and looks down on the conveyor 18. For the purpose of a better image resolution, illumination devices can be provided beneath a conveyor unit (such as a belt) of the first conveyor, wherein in this case it is recommended to implement the conveying unit of the first conveyor 18 in a transparent manner. In this manner, the resolution or the contrast can be increased such that an object recognition software can determine even chaotically arranged articles such as they might be present in the collection 74, with respect to their positions and orientations relative to the first conveyor 18. Corresponding software packages are commercially available. The same applies for the camera system.

Each of the two gripping units 30 of FIG. 4 supplies preferably two secondary conveyors 52 with articles, which are arranged perpendicular relative to the first conveyor 18. Respectively one buffer 35 dedicated to one or more order load supports, in the present case to order containers 34, is laterally provided relative to the second conveyors 32. Conveyors which transport the order containers 34 to the buffers 35 and transport same from the buffers 35 to a goods issue, which is not depicted here, are not depicted for the purpose of clarity. Similar applies for the discharging devices 66, which are exemplarily shown in the left second conveyor 32 of the upper fully automated and manlessly operated order-picking station comprising the first gripping unit 30.

In this case, the second conveyors 32 are arranged on the same level like the first conveyor 18. Up to forty picking orders can be processed in parallel by means of the arrangement shown in FIG. 4, since each of the buffers 35 comprises five destinations at which the order containers 34 can be positioned.

Similar to FIG. 3, the order load supports 34 can also be transported, however, in parallel relative to the first conveyor 18 in the area of the gripping units 30, namely at the preferably identical velocity like the articles on the first conveyor 18. In this case, picking orders can be processed by both of the gripping units 30 in a serial manner. The gripping unit 30 being depicted in the upper part of FIG. 4 could put all the articles from the first conveyor 18 into an order load support 34 in a first cycle, the order load support then being arranged relative to the first conveyor 18 so that the upper edge of the order load support 34 is either on the same level as the top surface of the first conveyor 18, or lies beneath same. All the articles which cannot be handled by the first upper gripping unit 30, because the articles leave the gripping area, can be put into the order load support 34 which is carried along with in a parallel manner by the second gripping unit 30 subsequently.

Returning to the embodiment shown in FIG. 4, it is to be noted that articles can be transported towards the gripping unit 30 in different manners. In FIG. 4 trays 72 are graphically represented by rectangles, having a grid, on the first conveyor 18, the trays being loaded preferably with articles of one sort only. In the upper part of FIG. 4 a loaded tray 72 and in the lower part an empty tray 72 are shown. The empty tray 72 has passed the gripping units 30 and was emptied by the gripping units 30. Rectangles without a grid structure graphically represent storage containers 70. Darkened storage containers 70, which are transported in an upper region of the first conveyor 18 in FIG. 4, graphically represent full order containers 70. Empty order containers 70 are depicted in white (compare the lower part of the circular system 19 holding one single empty storage container 70). The trays 72 and the containers 70 can be stored in racks of the warehouse 16.

The warehouse 16 is partially sectioned in FIG. 4. A rack aisle 75 is shown in this region, wherein a storage and retrieval device 76 can move along the rack aisle and vertically relative to front faces of the rack within the rack aisle. In the present case, the storage and retrieval device 76 can comprise two load handling devices enabling a simultaneous transport of two load supports (container and/or tray). In the upper rack, for example, containers 70 are stored. In the lower rack, for example, trays 72 are stored.

With reference to FIG. 4, a top view of isolated parts of another modification is depicted.

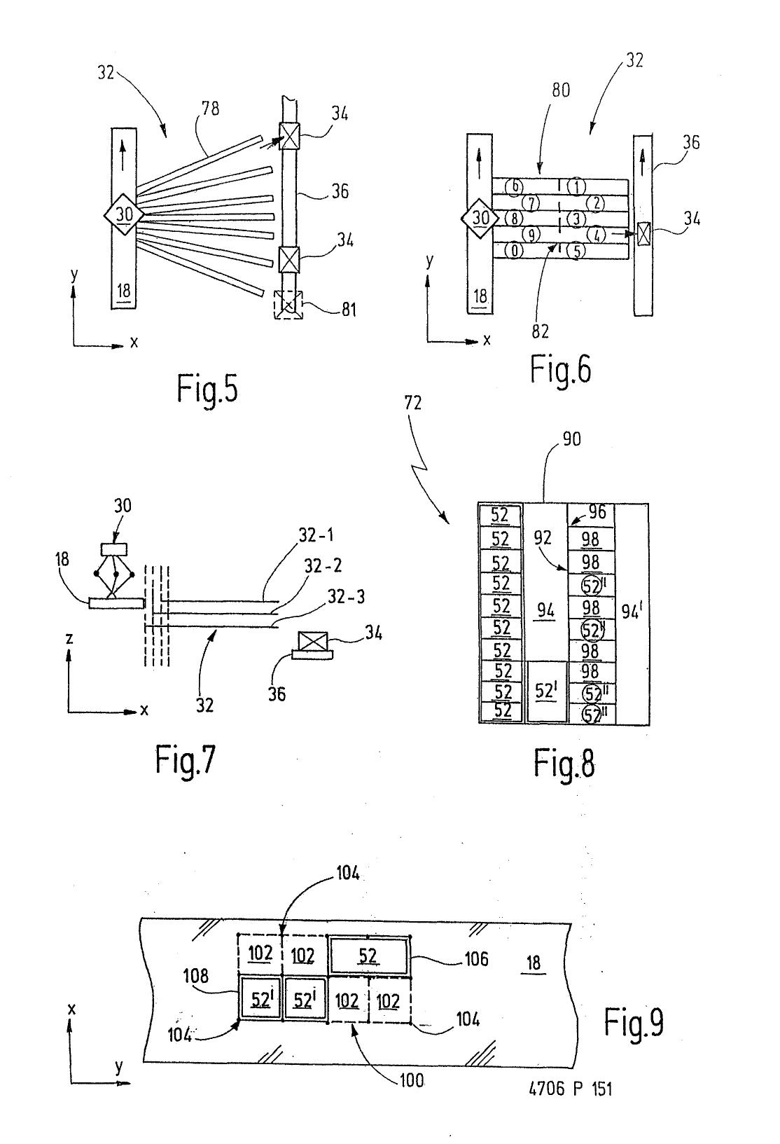

FIG. 5 shows a gripping unit 30 which is arranged above a first conveyor 18 and is capable of supplying a plurality of tracks 78 with articles. The left ends of the conveyor tracks 78 all end in the working area of the gripping unit 30. The opposing ends of the conveyor tracks 78 end at destinations 81, which are arranged in the present case on a conveyor 36 dedicated to order containers 34. It is possible that at each of the ends of the conveyor tracks 78, which are opposing the gripping unit 30, one order container 34 is positioned at a destination 81, one of which is indicated in FIG. 5 by means of a dashed line.

The conveyor tracks 78 can be implemented, for instance, by driven roller tracks or belts. Alternatively, gravity tracks can be used as well, which can be formed, for example, by an inclined, relative to a horizontal line, sheet metal (chute) or by means of an inclined, relative to the horizontal line, idle roller track.

With reference to FIG. 6, another modification is shown in top view.

Similar to FIG. 5, a gripping unit 30 is arranged above a first conveyor 18 in the left part of FIG. 6. A plurality of accumulation conveyors 80, here five accumulation conveyors 80 in total, couple laterally to the first conveyor 18. Opposing ends of the accumulation conveyors 80 also couple to a conveyor 36 dedicated to order containers 34.

The length of the accumulation conveyors can be selected arbitrarily. If the accumulation conveyors are sufficiently long, a stopper 82, which can be lifted and lowered, can be provided in the middle thereof as indicated by a dashed line in FIG. 6, in order to divide the accumulation conveyors into a number of sections or tracks.

Five accumulation conveyors being arranged in parallel adjacent to each other are shown in FIG. 6, which can be divided into ten accumulation sections in total by means of the stopper 82. These ten accumulation sections are depicted by circles containing consecutive numbers 0 to 9.

Articles delivered to the gripping unit 30 via the first conveyor 18 can be transferred to one of the five accumulation conveyors 50 in dependence on the picking order. It is clear that each of the accumulation conveyors 80 has an end which is located in the working area of the gripping unit 30.

As soon as all of the articles of one picking order are collected in one of the accumulation sections 1 to 5, the corresponding stopper element 82 of this accumulation conveyor 80 can be lifted so that the second accumulation section is available for another picking order.

Then, completely picked orders can be recalled and received by passing order containers 34.

With reference to FIG. 7, a side view of another embodiment is shown.

In this case, three secondary conveyors 32-1, 32-2 and 32-3 are vertically arranged one on top of the other on the right hand side of the gripping unit 30 which in turn is arranged above a first conveyor 18. At an end opposite to the gripping unit 30, a conveyor 36 dedicated to order containers 34 is arranged.

The three conveyors 32-1 to 32-3 are arranged such that vertical delivery windows arise in the delivery area of the gripping unit 30, which are indicated by vertical dashed lines in FIG. 7. The gripping unit 30 needs to be moved the longest way in the X direction for supplying the upper conveyor 32-1 with articles. In order to supply the lowermost conveyor 32-3 with articles, the gripping unit 30 needs to travel the shortest distance in the X direction. The centeral conveyor 32-2 requires a movement of the gripping unit 30 within a central range of the X direction.

Here, the conveyors 32-1 to 32-3 are driven so that the articles can be moved in FIG. 7 from the left to the right towards the order containers 34. In this case, gravity tracks can be used as well, thereby allowing omitting the drive. Further, the secondary conveyors 32 can be horizontally arranged relative to each other including an angle, like it is shown already for the gravity conveyor 78 in FIG. 5. The second conveyors 32 of FIG. 7 can also be arranged alternatively in a higher number side-by-side in a parallel manner, as it is shown in FIG. 6.

It is clear that the variations of the arrangement of the second conveyors 32, as shown in the figures, can be combined arbitrarily with each other.

With reference to FIG. 8, a tray 72 is shown as used for allowing presenting the entire article assortment at the gripping unit 30 in one hour, as already explained above.

The tray 72 comprises a surrounding edge 90. Compartment separations 92 can be provided in the interior of the tray 72 along a longitudinal direction, in order to define, for example, four tray rows. In FIG. 8 the left tray row is completely loaded with articles 52. The tray row 94 adjacent thereto comprises only one article 52′. The second tray row, from the right, in turn is divided into a plurality of individual tray compartments 98 by means of additional compartment separations 96. Some of these individual tray compartments 98 are filled with articles 52″. The tray row 94′ being depicted at the right hand side of FIG. 8 is empty.

With reference to FIG. 9, it will be explained how to grip articles from the first conveyor 18 by means of the gripping unit 30 in a safe and reliable manner although no image recognition unit 38 is used (contrary to FIGS. 1 and 4).

For this purpose, imaginary windows 100 are defined on the first conveyor 18 in the control unit. The imaginary windows 100 are imaged by imaginary fields 102 which in turn are limited by imaginary raster points 104 in corners thereof. The articles 52 are preferably put individually on correspondingly formed article trays 106, 108. The base area of the article trays 106, 108 corresponds in this context preferably to the base area of the different article types 52, 52′. One ashlar 52 and two cubes 52′ are respectively provided on their own trays 106 and 108 in FIG. 8. The trays 106, 108 are orientated along the raster points 104, and put on the raster fields 102. This process happens, for example, in the region of the goods receipt 12 and/or the warehouse 16. Loading devices provided for this purpose are controlled by the superordinated control unit 69 such that the trays 106, 108 are put on the raster fields being provided for this purpose.

Thus, the gripping unit 30 is provided with absolute position data of the articles 52, 52′ relative to the first conveyor 18. Since the articles 52, 52′ respectively stand on their own load supports 106, 108, it is irrelevant for the gripper 46 being formed in this case by means of mechanical pincers which article is actually stored on the load supports 106, 108. Separation of the articles 52, 52′ from the load supports 106, 108 only happens at a later time.

In this manner it is possible to save the image recognition unit 38 and the computing expenditure associated therewith. It is clear that also the article load supports can be omitted, if necessary.

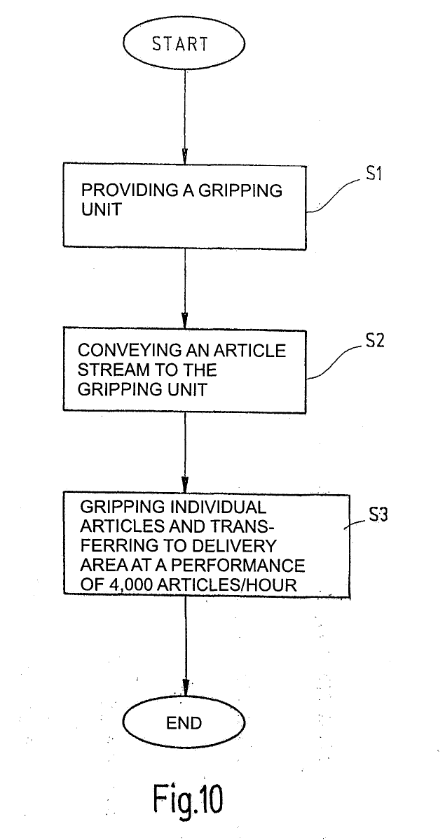

With reference to FIG. 10, a flow chart of the method of the present invention is shown.

In a first step S1, a gripping unit 30 is provided. An article stream towards the gripping unit 30 via the first conveyor 18 is conveyed in a second step S2. In a third step S3, the gripping unit grips individually determined articles from the stream and puts the same into the delivery area, wherein the gripping unit works at a performance of up to 1,500 articles each hour, or even up to 4,000 articles each hour.

Further, it is clear that the present invention can also be used for handling returning goods. Returning goods represent article shipments which are sent back by the customers and need to be stored back subsequently into the warehouse. Returning goods shipments are characterized in that many different articles are contained, in most times at low numbers. The articles of the returning goods shipment can be put on the first conveyor and conveyed as a group to the gripping unit. An image recognition unit being located downstream relative to the gripping unit records an image. By means of corresponding algorithms for resolving contours, the positions and orientations of the individual articles can be resolved. Gripping unit control data are in turn generated therefrom, which allow the safe and reliable gripping of the articles even if the first conveyor is continuously operated at the same time. If the articles are provided in stacks on the first conveyor, strippers can be used for resolving the stacks, thereby generating one individual layer of articles. Brush-like devices can be used as strippers, which are arranged horizontally in different heights transverse over the first conveyor. It is clear that such stack-resolving devices, of course, can also be used with the picking of normal articles, particularly if the gripping unit grips directly from the first conveyor, and thus not from the load supports.

After a completed transfer of the returning articles onto a second conveyor, these articles can be guided past specific article identification devices, in order to identify the article type. Identified articles can be buffered until the superordinated computer has fetched the right storage container, in order to store the buffered article back into a container being assigned to the article type.

It is clear that in the above given description the containers can be exchanged by another load support such as a tray at any time without departing from the invention. The same applies with respect to the conveyor. The utilization of belts was described predominantly. The utilization of other types such as roller conveyors, chain conveyors, etc. is possible in the same manner.

What is claimed is:

1. A storage and picking system, wherein different articles can be picked in a fully automated manner, which can be stored in or on storage load supports, to order load supports in accordance with a picking order, comprising:
an order-picking station;
an article warehouse;
a first conveyor for conveying the different articles from the article warehouse by means of an article stream downstream to the order-picking station; at least one gripping unit, which can be lifted and lowered, for gripping one arbitrary article from the article stream at a receiving point within a gripping area of the first conveyor, and for transferring the gripped article to a delivery point outside the gripping area, wherein the receiving point and the delivery point are located within a working area of the gripping unit, wherein during a transfer the one arbitrary article is vertically lifted from the article stream, displaced in a horizontal direction and subsequently moved vertically downwards, and wherein the gripping unit is adapted to grip and transfer up to 1,500 articles each hour; a control unit for coordinating the gripping and transferring movements of the gripping unit such that the articles in the stream, which are predetermined by the picking order, are gripped and transferred individually; and
an order load support buffer for buffering one or more order load supports at a corresponding number of destinations, wherein the buffer is coupled to the gripping unit.

2. The storage and picking system of claim 1, further comprising an image recognition unit for detecting and evaluating a location and an orientation of each of the articles in the stream on the first conveyor, wherein the image recognition unit is arranged upstream relative to the gripping unit and is adapted to resolve and identify the articles in the article stream, even if they are chaotically orientated.

3. The storage and picking system of claim 1, wherein each of the articles in the article stream is respectively conveyed on one article load support on the first conveyor into the gripping area, and is gripped and transferred there together with the respective article load support.

4. The storage and picking system of claim 1, wherein the gripping unit is adapted to transfer an article having a total weight of up to 2 kg at an acceleration of up to 150 m/s².

5. The storage and picking system of claim 1, wherein the working area has a diameter of up to 1,500 mm.

6. The storage and picking system of claim 1, wherein at least a second conveyor is provided, which couples, in the working area of the gripping unit, obliquely to the first conveyor and is connected to the order load support buffer.

7. The storage and picking system of claim 6, wherein the second conveyor comprises at least one of a plurality of driven accumulation conveyors and a plurality of gravity conveyors, each of which ends at one of the destinations.

8. The storage and picking system of claim 6, wherein the second conveyor is arranged together with the first conveyor on a same height.

9. The storage and picking system of claim 1, wherein the control unit is adapted to regulate a conveyor velocity of the first conveyor in dependence on an article density on the first conveyor.

10. The storage and picking system of claim 1, further comprising at least one of a goods receipt and a shipping area, coupled to the gripping unit via the first conveyor.

11. The storage and picking system of claim 1, further comprising an order load support conveyor, which runs in the working area of the gripping unit beneath the first conveyor and connects the destinations to the shipping area.

12. The storage and picking system claim 1, wherein the first conveyor is adapted to convey up to 1,800 storage load supports each hour through the gripping area, wherein the storage load supports are respectively loaded by articles of one sort only.

13. The storage and picking system of claim 1, wherein the control unit is adapted to track receiving points while the first conveyor is continuously operated, such that the gripping unit can grip articles from the first conveyor without stopping the first conveyor.

14. A method of picking a plurality of different articles, in a manless and fully automated manner, from storage load supports to order load supports in accordance with a picking order, comprising the steps of:
providing a gripping unit;
conveying a stream of articles, which are to be picked and which can be orientated chaotically, from an article warehouse to the gripping unit on a first conveyor;
gripping individual articles from the article stream on the first conveyor, and transferring the gripped articles to a delivery area which is coupled to order load supports, which are buffered in an order load support buffer being adapted to receive one or more order load supports,
wherein the gripping unit puts and transfers up to 1,500 articles each hour.

15. The method of claim 14, wherein the articles are either detected by means of an image recognition unit, before they are gripped and transferred, in order to respectively determine a location and orientation thereof, or orientated along predetermined raster points.
